(19) United States
(12) Patent Application Publication
(10) Pub. No.: US 2026/0235167 A1
(43) Pub. Date: Aug. 13, 2026

(54) DOUBLE OFFSET CONSTANT VELOCITY JOINT

(71) Applicant: JTEKT CORPORATION, Kariya-shi (JP)

(72) Inventors: Masahito IKEO, Anjo-shi (JP); Koji KUBO, Kariya-shi (JP); Kai SUZUKI, Takahama-shi (JP)

(73) Assignee: JTEKT CORPORATION, Kariya-shi (JP)

(21) Appl. No.: 19/474,025

(22) PCT Filed: May 2, 2023
(86) PCT No.: PCT/JP2023/017176

§ 371 Date: Oct. 9, 2025

(51) Int. Cl. F16D 3/226; F16D 3/223

(52) U.S. Cl. CPC F16D 3/2265; F16D 2003/22303; F16D 2300/08

(57) ABSTRACT

A double offset constant velocity joint includes an outer ring, an inner ring, and a plurality of balls, in which the outer ring has first wall portions in which outer ring ball grooves are formed, and second wall portions are each situated between two first wall portions that are adjacent in a circumferential direction, and outer faces of the first wall portions protrude outward in a radial direction beyond outer faces of the second wall portions, and a thickness of the first wall portions at contact portions between the outer ring ball grooves and the balls, a thickness of groove bottoms of the outer ring ball grooves of the first wall portions, and a thickness of the second wall portions, are set to values that satisfy Expression (1): Ta>Tc≥Tb . . . (1).

### TECHNICAL FIELD

The present disclosure relates to a double offset constant velocity joint.

### BACKGROUND ART

The following Patent Documents 1 and 2 disclose double offset constant velocity joints. A constant velocity joint of the cited document 1 is assembled in a propeller shaft of a vehicle. Also, a constant velocity joint of the cited document 2 is assembled in a driveshaft of a vehicle. These constant velocity joints include an outer ring that is cylindrical and is linked to one of shaft end portions of one of an input shaft and an output shaft, an inner ring that is disposed on an inner side of the outer ring and linked to the other shaft end portion of the input shaft or the output shaft, a plurality of balls for transmitting torque, and a cage for holding the plurality of balls. An inner peripheral face of the outer ring is provided with a plurality of outer ring ball grooves extending in an axial direction. An inner peripheral face of the inner ring that has a convex spherical shape is provided with a plurality of inner ring ball grooves extending in the axial direction. Balls are provided rollably between the respective outer ring ball grooves of the outer ring and the respective inner ring ball grooves of the inner ring. In this constant velocity joint, a center of a spherical outer face and a center of a spherical inner face of the cage are offset on opposite sides of the axial direction, with respect to a joint center.

### RELATED ART DOCUMENTS

### Patent Documents

Patent Document 1: Japanese Unexamined Patent Application Publication No. 2014-9715 (JP 2014-9715 A)
Patent Document 2: Japanese Unexamined Patent Application Publication No. 2011-231792 (JP 2011-231792 A)

### SUMMARY OF THE INVENTION

The double offset constant velocity joints that are disclosed in Patent Documents 1 and 2 are relatively lightweight among slide-type constant velocity joints that allow relative movement in the axial direction between the input shaft and the output shaft, but in designing constant velocity joints of this type, there is a demand for further weight reduction technology to improve fuel mileage and electric mileage of vehicles, while ensuring necessary strength.

An object of the present disclosure is to provide a double offset constant velocity joint that is capable of achieving weight reduction while ensuring the necessary strength.

### Means for Solving the Problem

One aspect of the present disclosure is a double offset constant velocity joint including an outer ring that is cylindrical and that has a plurality of outer ring ball grooves extending in an axial direction on an inner peripheral face of the outer ring, an inner ring that is disposed inside the outer ring and that has a plurality of inner ring ball grooves extending in the axial direction on an outer peripheral face of the inner ring, a plurality of balls for transmitting torque, the balls being rollably provided between the respective outer ring ball grooves and the respective inner ring ball grooves, and a cage for holding the plurality of balls between the outer ring and the inner ring, in which the cage has a spherical outer face and a spherical inner face, and a center of the spherical outer face and a center of the spherical inner face are offset to opposite sides in the axial direction with respect to a joint center, the outer ring has first wall portions in which the outer ring ball grooves are formed, and second wall portions that are situated on both sides of the first wall portions in a circumferential direction (Z), and outer faces of the first wall portions protrude outward in a radial direction beyond outer faces of the second wall portions, and a thickness (Ta) of the first wall portions at contact portions between the outer ring ball grooves and the balls, a thickness (Tb) of the first wall portions of at groove bottoms of the outer ring ball grooves, and a thickness (Tc) of the second wall portion, are set to values that satisfy the following Expression (1): Ta>Tc≥Tb . . . (1).

### Effects of the Invention

The outer ring of the double offset constant velocity joint in the above aspect is configured such that the thickness of the first wall portions at contact portions between the outer ring ball grooves and the balls, the thickness of the first wall portions at the groove bottoms of the outer ring ball grooves, and the thickness of the second wall portions, are set to satisfy Expression (1). Of these three parts of the outer ring, the contact portions between the outer ring ball grooves and the balls directly bear the load from the balls, and therefore are particularly important parts in terms of strength management of the outer ring.

Therefore, it is effective to use the contact portions between the outer ring ball grooves and the balls as a reference, set the thickness at these contact portions to be the largest, and then set the thicknesses at the remaining two parts of the outer ring based on this thickness. Setting in this way enables the remaining two parts of the outer ring to be suppressed from becoming excessively thick, and increase in the weight of the outer ring due to excessive thickness of these parts can be suppressed.

According to the above aspect, a double offset constant velocity joint can be provided that is capable of achieving weight reduction while ensuring the necessary strength. Note that reference signs in parentheses in the claims represent the corresponding relations with specific means described in embodiments to be described later, and are not intended to limit the technical scope of the present disclosure.

### BRIEF DESCRIPTION OF THE DRAWINGS

The above object and other objects, features and advantages of the present disclosure will become more apparent from the following detailed description with reference to the accompanying drawings. In the drawings;

FIG. 1 is an axial direction cross-sectional view of a double offset constant velocity joint according to a first embodiment;

FIG. 2 is a radial direction cross-sectional view of an outer ring and a boot in FIG. 1;

FIG. 3 is an enlarged view of region B in FIG. 2; and

FIG. 4 is an enlarged view of region A in FIG. 1.

### MODES FOR CARRYING OUT THE INVENTION

Hereinafter, a double offset constant velocity joint according to one embodiment of the above-described aspect will be described with reference to the drawings.

### First Embodiment

### 1. Overall Structure of Double Offset Constant Velocity Joint 10

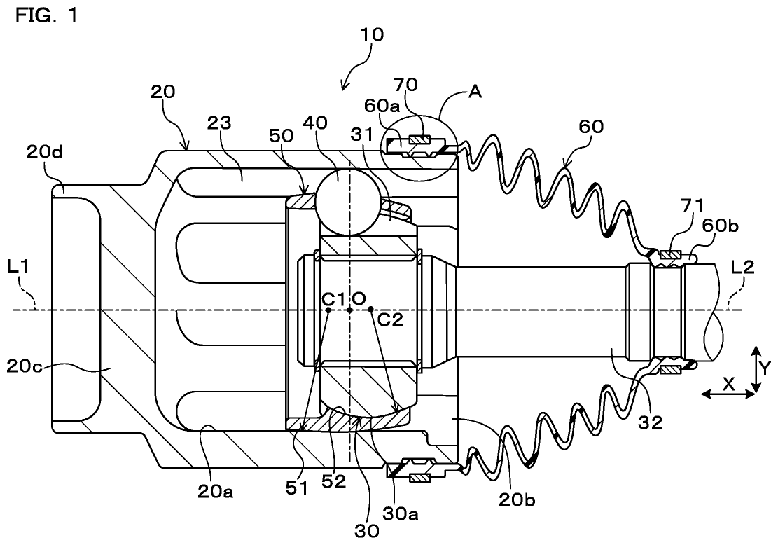

A double offset constant velocity joint (hereinafter simply referred to as a “constant velocity joint”) 10 of the first embodiment that is illustrated in FIG. 1 is a ball-type constant velocity joint with a movable joint center. This constant velocity joint 10 is used, for example, in a propeller shaft for transmitting power from an internal combustion engine or an electric motor to a differential device in a vehicle. This constant velocity joint 10 includes, as primary components thereof, an outer ring 20, an inner ring 30, a plurality of balls 40, a cage 50, and a boot 60.

Note that in FIG. 1, the right side in the drawing is an opening side of the outer ring 20 (outer ring opening side), and the left side in the drawing is a rear side of the outer ring 20 (the outer ring rear side or the side opposite the opening). Also, in FIG. 1 and other drawings, an axial direction is indicated by arrow X, a radial direction is indicated by arrow Y, and a circumferential direction is indicated by arrow Z.

### 2. Structure of Outer Ring 20

As illustrated in FIG. 1, the outer ring 20 is formed as a bottomed cylindrical member that has an opening portion 20b on the right side in the drawing. A linking shaft portion 20d is integrally formed on an outer side (left side in the figure) of a bottom portion 20c of this outer ring 20, so as to extend in the axial direction X. The linking shaft portion 20d is connected to a power transmission shaft (omitted from illustration). An inner peripheral face 20a of the outer ring 20 is formed straight in the axial direction X. The inner peripheral face 20a of the outer ring 20 is provided with a plurality of outer ring ball grooves 23 extending in the axial direction X that is substantially parallel to the outer ring axial line L1. Note that while not specifically illustrated, during a manufacturing process of the outer ring 20, a heat treatment coil is inserted into a cylindrical space of the outer ring 20 and heat treatment is executed.

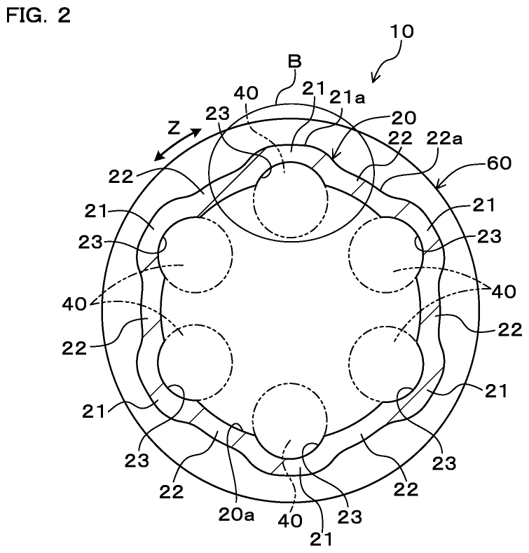

As illustrated in FIG. 2, the outer ring ball grooves 23 of the outer ring 20 are disposed at equal intervals in the circumferential direction Z as viewed in a radial cross-section taken along the radial direction Y that is orthogonal to the outer ring axial line L1. Each of the outer ring ball grooves 23 is formed such that a radial cross-sectional shape thereof is substantially an arcuate concave shape. Note that in the present embodiment, a case in which the number of the outer ring ball grooves 23 and the number of the balls 40 are both six is exemplified.

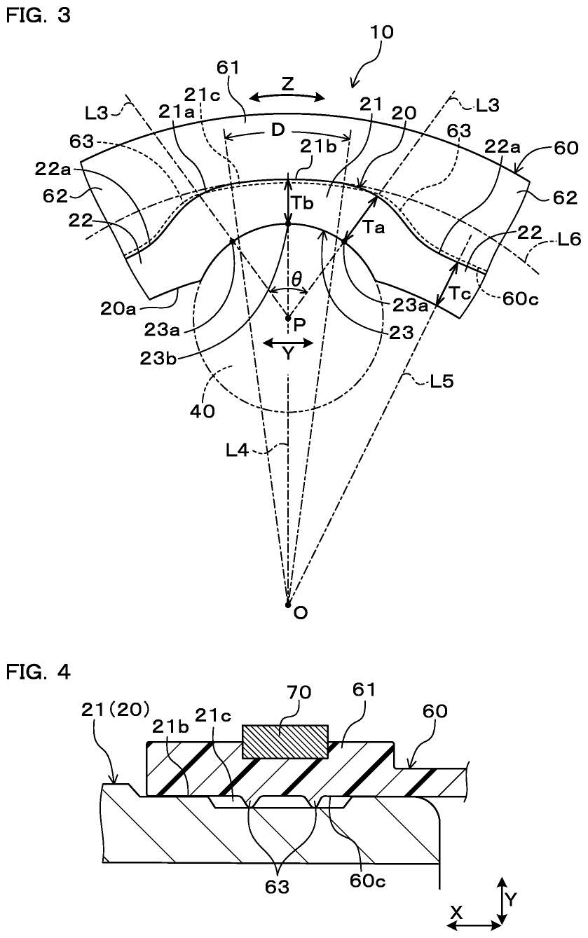

As illustrated in FIG. 2 and FIG. 3, the outer ring 20 has first wall portions 21 that are parts in which the outer ring ball grooves 23 are formed, and second wall portions 22 that are parts situated on both sides of the first wall portions 21 in the circumferential direction Z. The second wall portions 22 are each situated between two of the first wall portions 21 that are adjacent to each other in the circumferential direction Z. Accordingly, the cylindrical portion of the outer ring 20 is divided into first wall portions 21 and second wall portions 22, and these first wall portions 21 and second wall portions 22 are disposed alternately in the circumferential direction Z. The outer ring 20 is configured such that outer faces 21a of the first wall portions 21 protrude outward in the radial direction Y beyond outer faces 22a of the second wall portions 22. The outer faces 21a of the first wall portions 21 include outermost diameter portions of the outer ring 20.

### 3-1. Thickness of Outer Ring 20

As illustrated in FIG. 3, in the present embodiment, dimensional settings are made such that the thickness of the outer ring 20 is different at each part in the circumferential direction Z. Specifically, when the thickness of the first wall portion 21 at contact portions 23a between the outer ring ball grooves 23 and the balls 40 is defined as Ta, the thickness of the first wall portions 21 at groove bottoms 23b of the outer ring ball grooves 23 is defined as Tb, and the thickness of the second wall portions 22 is defined as Tc, the thickness Ta, the thickness Tb, and the thickness Tc are set to values that satisfy the following Expression (1).

$$Ta > Tc \geq Tb . \qquad ( 1 )$$

Here, the thickness Ta is a thickness of the first wall portion 21 on imaginary straight lines L3 passing through a ball center P of the ball 40 and the contact portion 23a. That is to say, this thickness Ta corresponds to a thickness dimension of the contact portions 23a of the first wall portion 21 in the radial direction of the ball 40 (radial distance from contact portions 23a to outer face 21a of first wall portion 21). An angle θ between the two imaginary straight lines L3 is a contact angle between the two contact portions 23a.

The thickness Tb is the thickness of the first wall portion 21 on an imaginary straight line L4 passing through a joint center O, the ball center P, and the groove bottom 23b of the outer ring ball groove 23. That is to say, this thickness Tb corresponds to the thickness dimension at the groove bottom 23b of the first wall portion 21 in the radial direction of the constant velocity joint 10 (radial distance from groove bottom 23b to outer face 21a of first wall portion 21).

The thickness Tc is the thickness of the second wall portion 22 on an imaginary straight line L5 extending in the radial direction Y from the joint center O toward the second wall portion 22. That is to say, this thickness Tc corresponds to the thickness dimension of the second wall portion 22 in the radial direction of the constant velocity joint 10.

In the case of Expression (1), the thickness Ta is set to be greater than either or the thickness Tb and the thickness Tc. Also, the thickness Tc is set to be the same as the thickness Tb or to be greater than the thickness Tb.

Of the first wall portion 21, the contact portion 23a between the outer ring ball groove 23 and the ball 40 is a part on which the ball 40 directly comes into sliding contact, and receives load from the ball 40 directly. For this reason, in the present embodiment, the thickness Ta of the first wall portion 21 at the contact portion 23a is set to be the greatest. The remaining thicknesses Tb and Tc are set in a range below the thickness Ta, in accordance with strength that is required at each part. In this case, the thicknesses Tb and Tc can be kept from becoming greater than necessary, and weight reduction of the outer ring 20 can be realized accordingly. As a result, the fuel mileage and the electric mileage of the vehicle in which the constant velocity joint 10 is installed can be improved.

Note that an inner face of the second wall portion 22 of the outer ring 20 is a smallest diameter part at which a bore diameter is smaller than the bore diameter of an inner face of the first wall portion 21. Accordingly, the inner face of the second wall portion 22 is located at a position that is closest to the heat treatment coil, during the heat treatment of the outer ring 20, described earlier. Accordingly, the second wall portion 22 has a greater effect of improved strength through the heat treatment, as compared to the first wall portion 21. Taking this point into consideration, the thickness Tb of the second wall portion 22 can be set to be smaller than the thickness Ta of the first wall portion 21, as in Expression (1).

Also, in relation to Expression (1), the thickness Ta, the thickness Tb, and the thickness Tc can be set to values that satisfy the following Expression (2).

$$Ta > Tc > Tb \qquad ( 2 )$$

In the case of Expression (2), similarly to the case of Expression (1), the thickness Ta is set to be greater than both the thickness Tb and the thickness Tc. Moreover, the thickness Tc is set to be greater than the thickness Tb.

As in Expression (2), setting the thickness Tb to be smaller than the thickness Tc enables the outermost diameter of the outer ring 20 to be made smaller as compared to, for example, a uniform thickness specification in which the thickness of the outer ring 20 in the radial direction Y is made constant to match the thickness Tc, and also weight reduction can be realized by an amount corresponding to a thickness equivalent to the difference between the thickness Tc and the thickness Tb. Accordingly, reduction in size and weight reduction of the outer ring 20 can be realized. In this case, the reduction in size of the outer ring 20 is effective in improving the installability of the constant velocity joint 10 in a vehicle, and the weight reduction of the outer ring 20 is effective in improving the fuel mileage and the electric mileage of the vehicle.

### 4. Structure of Inner Ring 30

As illustrated in FIG. 1, the inner ring 30 is formed in an annular shape and is disposed on an inner side of the outer ring 20. An outer peripheral face 30a of this inner ring 30 is formed as a convex spherical shape. The inner ring 30 is linked to a power transmission shaft 32. A plurality of inner ring ball grooves 31 is provided on the outer peripheral face 30a of the inner ring 30, extending in the axial direction X that is substantially parallel to an inner ring axial line L2. The plurality of inner ring ball grooves 31 is disposed at equal intervals in the circumferential direction Z as viewed in a radial cross-section that is taken in the radial direction Y perpendicular to the inner ring axial line L2. The inner ring ball grooves 31 are provided in the same number as the outer ring ball grooves 23, and also each of the inner ring ball grooves 31 and each of the outer ring ball grooves 23 are disposed to face each other in the radial direction Y. Each of the inner ring ball grooves 31 is formed such that a radial cross-sectional shape thereof is substantially an arcuate concave shape.

### 5. Structure of Balls 40

As illustrated in FIG. 1, the balls 40 are provided rollably between the respective outer ring ball grooves 23 of the outer ring 20 and the respective inner ring ball grooves 31 of the inner ring 30. The plurality of balls 40 is disposed in the circumferential direction Z, and the balls 40 are interposed between the outer ring ball grooves 23 of the outer ring 20 and the inner ring ball grooves 31 of the inner ring 30 in the radial direction Y. Each of the balls 40 functions to transmit torque between the outer ring 20 and the inner ring 30.

### 6. Structure of Cage 50

As illustrated in FIG. 1, the cage 50 is used to hold the plurality of balls 40 between the outer ring 20 and the inner ring 30. This cage 50 is formed in an annular shape and is disposed between the inner peripheral face 20a of the outer ring 20 and the outer peripheral face 30a of the inner ring 30. This cage 50 has a spherical outer face 51 of a convex spherical shape which comes into sliding contact with the inner peripheral face 20a of the outer ring 20, and a spherical inner face 52 of a concave spherical shape which comes into sliding contact with the outer peripheral face 30a of the inner ring 30 of a convex spherical shape. In this cage 50, a center C1 of the spherical outer face 51 and a center C2 of the spherical inner face 52 are offset with respect to the joint center O, on opposite sides of the axial direction X. Note that in the present embodiment, offset distance of the center C1 from the joint center O and offset distance of the center C2 from the joint center O are the same. The center C1 of the spherical outer face 51 and the center C2 of the spherical inner face 52 are offset from the joint center O by an equal distance.

As described above, the spherical outer face 51 of the cage 50 is formed by a portion of a sphere that is drawn with the center C1, which is a point that is offset by a predetermined distance from the joint center O toward the rear of the outer ring in the axial direction X, as the center of curvature. Also, the spherical inner face 52 of the cage 50 is formed by a portion of a sphere that is drawn with the center C2, which is a point that is offset by a predetermined distance from the joint center O toward the opening of the outer ring in the axial direction X, as the center of curvature.

### 7. Structure of Boot 60

As illustrated in FIG. 1, the boot 60 is extendable and compressible in the axial direction X, and is also formed in a bendable bellows tube form. This boot 60 is made of a flexible resin material or rubber material. One end portion 60a of the boot 60 in the axial direction X is fit onto an outer peripheral face of the opening portion 20b side of the outer ring 20, and is attached to the outer ring 20 by being fastened with a clamp 70 that is annular in shape. An other end portion 60b of the boot 60 in the axial direction X is fitted around the periphery of the power transmission shaft 32 and fastened by a clamp 71 that is annular in shape, thereby being attached to the power transmission shaft 32. This boot 60 functions to seal grease that is contained within an internal region of the outer ring 20 so as not to leak out.

As illustrated in FIG. 3, the boot 60 has first engaging portions 61 that engage the outer faces 21a of the first wall portions 21 of the outer ring 20, and second engaging portions 62 that engage the outer faces 22a of the second wall portions 22 of the outer ring 20. In this boot 60, the first engaging portions 61 and the second engaging portions 62 are provided alternately in the circumferential direction Z. The second engaging portions 62 have the same outside diameter as the first engaging portions 61 but have a smaller bore diameter than the first engaging portions 61.

As illustrated in FIG. 3 and FIG. 4, engaging protrusions 63 extending annularly along the circumferential direction Z are provided on an inner face 61c of the boot 60. The number and shape of the engaging protrusions 63 are not limited in particular, but in the present embodiment, a case is exemplified in which two engaging protrusions 63 are provided at a distance from each other in the axial direction X, and also the cross-sectional shape of each of the engaging protrusions 63 is substantially triangular.

The outermost diameter portion of the outer face 21a of the first wall portion 21 of the outer ring 20 is an arcuate face 21b that is concentric with the joint center O. This arcuate face 21b is a face along an imaginary circle L6 that is centered on the joint center O, and the dimension in the circumferential direction Z is a face that is indicated by an arc length D in FIG. 3. This arcuate face 21b is provided with a boot groove 21c into which the engaging protrusions 63 are fitted when the boot 60 is attached. The boot groove 21c is a groove portion of a constant depth (see FIG. 4). In contrast, the outer face 22a of the second wall portion 22 does not have a part corresponding to the boot groove 21c.

The arc length D of the arcuate face 21b is not limited in particular, but as one example, it is preferable to set the arc length D such that an angle around the joint center O is in a range of 20° to 30°. Such a setting is effective in making it difficult for the engaging protrusions 63 of the boot 60 to come out of the boot groove 21c of the outer ring 20.

In the outer ring 20 according to the present embodiment, the boot groove 21c of the first wall portion 21 is provided so as to be concentric with the joint center O, in the same way as with the arcuate face 21b of the outer face 21a. Making the boot groove 21c concentric with the joint center O in this way enables the boot groove 21c to be easily formed by turning processing of the arcuate face 21b of the first wall portion 21.

### 8. Effects and Advantages

Effects and advantages of the above first embodiment will be described.

The outer ring 20 of the constant velocity joint 10 according to the first embodiment is configured such that the thickness Ta of the first wall portions 21 at the contact portions 23a between the outer ring ball grooves 23 and the balls 40, the thickness Tb of the first wall portion 21 at the groove bottoms 23b of the outer ring ball grooves 23, and the thickness Tc of the second wall portion 22 satisfy the above Expression (1) or the above Expression (2). Of these three parts of the outer ring 20, the contact portions 23a between the outer ring ball grooves 23 and the balls 40 directly bear the load from the balls 40, and are therefore particularly important parts in terms of strength management of the outer ring 20.

Accordingly, in the present embodiment, the contact portions 23a between the outer ring ball grooves 23 and the balls 40 are used as a reference, and the thickness Ta at these contact portions 23a is set to be the greatest, following which the thicknesses Tb and Tc at the remaining two parts of the outer ring 20 are set based on this thickness Ta. Setting in this way enables the remaining two parts of the outer ring 20 to be suppressed from becoming excessively thick, and increase in the weight of the outer ring 20 due to excessive thickness of these parts can be suppressed.

Thus, according to the first embodiment, a constant velocity joint 10 can be provided in which weight reduction can be realized while ensuring the necessary strength.

Although the present disclosure has been described in accordance with the above-described form, it is understood that the present disclosure is not limited to such forms and structures. The present disclosure also encompasses various modifications and variations within the scope of equivalents. Additionally, various combinations and forms, as well as other combinations and forms that include only one element, more than this, or less than this, fall within the scope and spirit of the present disclosure.

In the above-described embodiment, a case in which the outermost diameter portion of the outer face 21a of the first wall portion 21 is the arcuate face 21b, is exemplified as the structure of the outer ring 20, but the outermost diameter portion of the outer face 21a may be a curved face other than an arcuate face, as necessary.

In the above embodiment, an example of the constant velocity joint 10 that is installed in the propeller shaft of a vehicle has been described, but the structure of this constant velocity joint 10 may also be applied to an arrangement that is installed in a drive shaft that is linked to wheels of a vehicle, and transmits power that is generated by a drive source such as an internal combustion engine, an electric motor, or the like, to the wheels.

1-4. (canceled)

5. A double offset constant velocity joint comprising:
an outer ring that is cylindrical and that has a plurality of outer ring ball grooves extending in an axial direction on an inner peripheral face of the outer ring;
an inner ring that is disposed inside the outer ring and that has a plurality of inner ring ball grooves extending in the axial direction on an outer peripheral face of the inner ring;
a plurality of balls for transmitting torque, the balls being rollably provided between the respective outer ring ball grooves and the respective inner ring ball grooves; and
a cage for holding the plurality of balls between the outer ring and the inner ring, wherein
the cage has a spherical outer face and a spherical inner face, and a center of the spherical outer face and a center of the spherical inner face are offset to opposite sides in the axial direction with respect to a joint center,
the outer ring has first wall portions in which the outer ring ball grooves are formed, and second wall portions that are situated on both sides of the first wall portions in a circumferential direction, and outer faces of the first wall portions protrude outward in a radial direction beyond outer faces of the second wall portions, and
a thickness (Ta) of the first wall portions at contact portions with the balls for torque transmission between the outer ring and the inner ring, a thickness (Tb) of the first wall portions at groove bottoms of the outer ring ball grooves, and a thickness (Tc) of the second wall portion, are set to values that satisfy the following Expression (1):
$$Ta > Tc \geq Tb . \qquad ( 1 )$$

6. The double offset constant velocity joint according to claim 5, wherein the thickness (Ta), the thickness (Tb), and the thickness (Tc) are set to values that satisfy the following Expression (2):
$$Ta > Tc > Tb \qquad ( 2 )$$

7. The double offset constant velocity joint according to claim 5, further comprising a boot that is attached to the outer ring, and engaging protrusions extending annularly along the circumferential direction are provided on an inner face of the boot, wherein a boot groove into which the engaging protrusions are fitted when the boot is attached is provided to the outer faces of the first wall portions such that the boot groove is concentric with the joint center.

8. The double offset constant velocity joint according to claim 7, wherein an outermost diameter portion of the outer faces of the first wall portions is an arcuate face that is concentric with the joint center, and the boot groove is provided on the arcuate face.
